(19) United States
(12) Patent Application Publication
(10) Pub. No.: US 2026/0235872 A1
(43) Pub. Date: Aug. 13, 2026

(54) HUD Image Quality by Means of the Dominant Eye, Which Is Determined via a Subjective HUD Image Assessment of the User

(71) Applicant: Bayerische Motoren Werke Aktiengesellschaft, Muenchen (DE)

(72) Inventor: Michael Arthur JANZER, Unterschleissheim (DE)

(21) Appl. No.: 19/532,044

(22) Filed: Feb. 6, 2026

(30) Foreign Application Priority Data
Feb. 7, 2025 (DE) 10 2025 104 633.6

(51) Int. Cl. G02B 27/01; B60K 35/231; G06F 3/01

(52) U.S. Cl. CPC G02B 27/0101; B60K 35/231; G06F 3/013; B60K 2360/23

(57) ABSTRACT

A method for operating a field-of-view display device, which includes an image generator for generating a light beam bundle having identical display content for both eyes and a reflection pane, so that the display content is displayed to a user via reflection on the reflection pane as a real or virtual image floating in the air. Current positions of both user eyes are dynamically determined, wherein a predistortion of the display content is predetermined for each point within an eyebox, which optimizes the image for a single eye positioned at this point. A pattern display content is displayed to the user, which is predistorted once for the current position of his left eye and once for that of his right eye, accompanied by a query on his subjective preference decision between these two representations and the storage of the eye thus selected as dominant.

### CROSS REFERENCE TO RELATED APPLICATION

This application claims priority under 35 U.S.C. §119 from German Patent Application No. 10 2025 104 633.6, filed February 7, 2025, the entire disclosure of which is herein expressly incorporated by reference.

### BACKGROUND AND SUMMARY

The invention relates to a method for operating a field-of-view display device, which is also known under the designation head-up display (HUD). Such devices can be used, for example, in a motor vehicle or another type of land, air, or water vehicle. They are used for generating a real or virtual image shown in the field of view of a user via reflection on a reflection pane, which is usually at least partially transparent, such as a windshield or rear window of the vehicle, or on a combiner pane provided separately for this purpose, which is arranged in the field of view of the user. The invention is also directed to a correspondingly configured control unit, a projection unit which is designed to output a suitable light beam bundle, a field-of-view display device containing these, and a vehicle equipped therewith.

In this context, for example, for motor vehicles, overlaying display content such as specifications about speed limits or other useful navigation and vehicle operating instructions in the form of a virtual image on the real surroundings observed by the driver in front of the vehicle by means of a head-up display, so that the driver does not have to look away from the road to read this display, is known. In classic design, an HUD comprises a projection unit housed below the windshield in the interior of the instrument panel. This projection unit typically contains a display which generates the desired display content, and a suitable imaging and projection optical unit, which usually contains a concave mirror in order to form the light beam bundle originating from the display and guide it onto the windshield so that it is reflected therefrom to the eyes of the driver and he can thus see the virtual image in a suitable size and distance beyond the windshield. This can also be provided similarly for the front passenger and/or other passengers in the vehicle. For a large-area, for example, panoramic virtual display, furthermore a simplified HUD design having a flat display screen or waveguide display extending directly in the windshield base area of the windshield, i.e., without imaging and projection optical unit such as concave mirror etc., is known.

In addition to a virtual image display, for example, the generation of a real image floating in the air for one or more observers in a vehicle by means of an imaging concave mirror is furthermore known from CN 217821128 U, wherein the beam path also leads via reflection on the windshield to the eyeboxes of a driver and a front passenger here.

A head-up display (HUD) generally does not display a perfect image, however. On the one hand, this is because of the general design layout of the system, on the other hand, because of unavoidable tolerances of the image generator, the projection unit, and the reflection pane in each specific device or vehicle. While the negative effects of the layout can be significantly reduced by corresponding optimization even during the development and the production, a calibration of the system after the installation in the vehicle has to be provided for the tolerances in each specific individual case. In spite of these measures, however, a perfect distortion-free image will almost never be obtained with a classic HUD. Even with dynamic warping (predistortion), which detects the positions of the eyes and adjusts the warping accordingly, this will not be possible as long as an autostereoscopic HUD is not used. The reason for this is that the dynamic warping can only balance the predistortion for a point between the two eyes (i.e., a cyclopean eye), which then does not result in the perfect distortion-free image for the left and for the right eye.

This problem is shown schematically and somewhat magnified and exaggerated for reasons of clarity in FIG. 4. The HUD image V_{ZA} / R_{ZA} is displayed perfectly for a cyclopean eye, which would be located between the real positions of the right and the left eye of the user, while the left and right eye each see a rotated and shifted image V_{LA} / R_{LA} or V_{RA} / R_{RA}. For further details, reference is made to a more extensive description of FIG. 4 following herein at the conclusion.

In this context, for example, DE 10 2021 211 703 A1 proposes a correction unit, which is configured for image generation of the head-up display and is adapted to the eye position within the eyebox. A predistortion of the image to be displayed can be performed from the recognized eye position by the correction unit, which ensures that the image visible from the recognized eye position is displayed well and distortion and/or color irregularities are reduced or minimized. The adjustment to the eye position is preferably an adjustment which is jointly adjusted to the position of at least two eyes (therefore a pair of eyes). This can be achieved, for example, by averaging the detected position of the two eyes. Since a pair of eyes does not have a very large distance, according to DE 10 2021 211 703 A1, an acceptable adjustment can be achieved for both eyes. However, a separate adjustment can also be carried out for each detected eye or the adjustment is only performed for one eye, for example, of a pair of eyes, for example, for the eye which is strong or dominant in vision.

Furthermore, JP 2005-138755 A discloses a virtual display system. This comprises a head-up display (HUD), which is installed in a vehicle and displays virtual images via reflection in its windshield, a focal point recognition camera, which records an image of an eye of a driver, and a gesture recognition camera, which records an image of a hand of the driver. When the driver points with the finger at a displayed virtual image, the HUD recognizes and processes the respective images recorded by the focal point recognition camera and the gesture recognition camera and defines a gaze direction of the driver, in that it recognizes the eye position and the finger position of the driver. The virtual images are thus defined on the eyeline. If the driver subsequently waves an object away with the hand, the image recorded by the gesture recognition camera is recognized and processed to establish that a command to delete the virtual image was input. The indicated virtual image is thus deleted. It is better here to use the gaze of the dominant eye than the gaze of the nondominant eye in order to locate an object.

The dominant eye is ascertained here on the basis of the fact that humans generally see an object in a location relationship as if it were seen either by the right or the left eye, thus by their “dominant eye”. This is particularly noticeable when pointing at objects which are far away, so that the driver in JP 2005-138755 A is displayed as a virtual image a predetermined symbol or word, such as “PUSH”, with the prompt to point at it with the finger, to identify the dominant eye. The dominant eye is identified in that it is located on a line with the displayed symbol/word and the position of the fingertip pointing thereon, while the other eye is not located on this connecting line.

It is an object of the present invention to specify a method for operating a field-of-view display device which is alternative and/or improved with regard to the display options, the image quality, the robustness, and/or other aspect and a correspondingly designed projection unit and field-of-view display device for a vehicle.

This object is achieved by a method for operating a field-of-view display device in a vehicle and by a corresponding control unit, projection unit, a field-of-view display device containing these, and a vehicle equipped therewith according to the independent claims. Further designs are specified in the dependent claims. All refining features and effects mentioned in the claims and in the following description for the method also apply with respect to the control unit, the projection unit, the field-of-view display device, and the vehicle, and also vice versa in each case.

According to a first aspect, a method for operating a field-of-view display device is provided. The field-of-view display device can be designed, for example, as a head-up display (HUD). It can (but not necessarily) be designed for use in a vehicle. The vehicle can be a motor vehicle, but also any other land, air, or water vehicle. If not indicated otherwise, in the case of use in the vehicle, the position specifications and spatial orientation terms mentioned herein such as “vertical”, “horizontal”, “left”, “right”, “below”, “above”, etc. relate to the typical vehicle-fixed Cartesian coordinate system having longitudinal, transverse, and vertical directions of the vehicle perpendicular to one another.

The field-of-view display device comprises an image generator, which is designed and configured to generate a light beam bundle having desired display content, which is identical for both eyes of a user. (The device is therefore not designed for autostereoscopic display.) Furthermore, the field-of-view display device comprises a reflection pane arranged in the field of view of the user which can (but not necessarily) be semitransparent. Optionally, the field-of-view display device can moreover comprise an imaging and/or projection optical unit designed for forming and guiding the light beam bundle generated by the image generator to the reflection pane, wherein it can, however, also be a design mentioned at the outset without imaging and/or projection optical unit. Depending on the application-specific design of the field-of-view display device and in particular its possibly provided imaging and/or projection optical unit, a real image that floats in the air between the user and the reflection pane, or a virtual image, which appears to the user to float beyond the reflection pane, is generated in operation. The user can be, for example, a driver, front passenger, or another occupant of the vehicle in the case of the use in a vehicle.

During the operation of the field-of-view display device, current positions of both user eyes are ascertained dynamically (in the sense of “continuously updated”, “running”, or “at each point in time”). Eye tracking sensors suitable for this purpose can comprise, for example, one or more cameras and can be present in any case onboard a vehicle for driver or occupant monitoring.

Such a predistortion of the desired display content is predetermined here for each point within an eyebox predetermined for user eyes such that the image display is optimized for the observation with a single eye positioned at this point. Such predistortion is also called “dynamic warping” since it depends on the dynamically ascertained position of the observing eye. Any deviations of the displayed image from an ideal image can thus be compensated for a single eye. As mentioned at the outset, such deviations can be caused, on the one hand, by position changes of the eye within the eyebox, but also by often unavoidable (installation) tolerances and/or layout properties of the overall optical system (such as the windshield curvature) which possibly cannot be or are not optimized otherwise.

As is typical, a two-dimensionally or three-dimensionally defined spatial area is understood herein as the eyebox, from which the image displayed by the field-of-view display device is visible unrestrictedly or in intended display quality. Upon the use in the vehicle, the respective user eyebox is specified in the passenger compartment and can be spatially restricted, for example, to the relevant seat.

In the present operating method, a predetermined pattern display content is displayed to the user upon a predetermined trigger, which is predistorted with a time interval that can be resolved by the human eye in succession once for the current position of his left eye and once for that of his right eye. Simultaneously or subsequently, a question about his subjective preference decision between these two displays is output to the user via an arbitrary suitable user interface (for example, optically and/or acoustically). If the user responds thereto, his response input (via the same or another user interface, for example, also via a button or touchscreen) is received and the one of his two eyes for which the display of the pattern display content selected by him was optimized is stored as dominant. This determination method of the dominant eye of a user of the field-of-view display device presented herein can be activatable, for example, automatically at the beginning of his first use of the field-of-view display device and/or at his command via a user menu.

The field-of-view display device is operated in the present method using the predistortion of the display content for the respective current position of the eye of this user stored as dominant or, if nothing is stored, for a respective position located in the center between the two user eyes (i.e., for a cyclopean eye).

While exclusively parallax-based methods for determining the dominant eye are found in the prior art, which always draw a connecting line between the dominant eye of the observer, his index finger, and a remote point/object at which he points, in the present case a subjective impression of the user is requested on the basis of a most informative possible pattern display content for the display performance, whether and which of his two eyes, for the same pattern display content, results in overall better predistortion for this specific field-of-view display device upon binocular observation. It has been shown that especially for large-area displays or for shape reproduction and/or color reproduction, this subjective selection of the user often leads to a completely different result than in the conventional parallax-based determination of his dominant eye (i.e., the user either sees no preference for one of his eyes or gives a different eye the preference than in the conventional parallax-based determination).

One concept of the presented method is therefore to solve the above problem illustrated in FIG. 4 by making use of the fact that most humans have a more or less strongly pronounced dominance of an eye, and an operation-friendly determination method based only on his subjective assessment of the image quality is provided to the respective user, of whether and which of his eyes is dominant for this special type of display. If one knows as a result of the determination method presented herein which is the dominant eye of the specific user (for example, the driver), during operation of the field-of-view display device, the dynamic warping can from then on be adjusted directly to the detected position of his dominant eye and therefore a perfect HUD image can be displayed to the driver.

The mentioned pattern display content is ideally predetermined so that it is as informative as possible for the user-side assessment of the display performance of the entire optical structure of the field-of-view display device. The pattern display content can contain patterns and colors for this purpose, for example, on the basis of which the shape and color reproduction in the displayed image can be seen well. In a simple case, for example, a calibration display content intended for the calibration of the system can also be used or used as the basis (and possibly supplemented with further color and shape variants).

In particular, the pattern display content can for this purpose also extend over at least a third, better over at least a half, and even better over the entire respective linear, surface or angle dimension of a display area that can be covered in total by the field-of-view display device (i.e., the so-called field of view, FoV) in the field of view of the user. An extensive foundation of information/decision can thus be provided to the user for the entire usable image size/image area for his subjective preference between the two performances of the field-of-view display device, which are each optimized to only one of his eyes.

As already mentioned, in the operating method presented herein, the above routine for determining a dominant eye of the user can be activatable, for example, by an automatic recognition of a new user of the field-of-view display device; by the reception of a user-side initial login as a user of the field-of-view display device; and/or by the reception of a separate user-side input predetermined for the mentioned determination of the dominant eye. The latter input can be enabled for the user, for example, via a suitable menu, wherein the relevant menu item can be indicated, for example, as “select the optimum HUD display for you” or “activate an automated determination of your dominant eye”.

The mentioned predistortion (i.e., dynamic warping), which has to be specified as a condition of the described operating method, can have been obtained, inter alia (but neither exclusively nor necessarily), by a calibration of the field-of-view display device, such as an HUD overall system after its installation in the vehicle, which compensates for the tolerances specific to the individual case or vehicle.

According to one embodiment, the mentioned predistortion is predetermined in preparation for the operation by a calibration procedure carried out at multiple calibration positions within the user eyebox, in which a compensating predistortion of tolerance deviations of the field-of-view display device due to (installation) structure has been ascertained and stored at each calibration position on the basis of at least one predetermined calibration display content and an optical camera replacing a single eye, which records the resulting image, by a predetermined manual and/or automated calibration routine. The predistortion can be determined here by an interpolation for all positions located between such calibration positions. The mentioned calibration positions can and should comprise at least five calibration positions here, for example, for a quadrilateral eyebox, which are defined in a two-dimensional eyebox oriented transverse to the beam propagation by its four eyebox corners and an eyebox center and therefore enable a reasonable interpolation. The inaccuracies which arise due to the interpolation can be reduced if even more camera positions are used in the calibration.

According to one embodiment, the field-of-view display device furthermore comprises an imaging and/or projection optical unit arranged in the beam path of the light beam bundle generated by the image generator and designed such that the light beam bundle is projected in a predetermined shape and direction onto the reflection pane in order to be reflected thereby to the eyes of the user and thus display the display content as a floating real or virtual image to him. For example, the imaging and/or projection optical unit can comprise at least one concave mirror, the angle of inclination of which with respect to an optical axis of the projection unit can be adjustable in order to change the propagation direction of the light beam bundle and therefore the image and eyebox position for adjustment to a user. The respective concave mirror can be designed, for example, for a deflecting, image-enlarging, imaging, collimating, and/or image-correcting optical function. Alternatively or additionally, the imaging and/or projection optical unit can also comprise other optical elements such as lenses, planar mirrors, etc. having this or other optical functionality.

Alternatively thereto, the field-of-view display device, for example, for a large-area or panoramic virtual display, can also be designed without imaging and projection optical unit such as concave mirrors etc. If installed in a vehicle, it can thus comprise, for example, a flat display screen or waveguide display extending in the windshield-base area of the windshield, the display content of which is reflected directly in the windshield or another combiner pane.

According to a further aspect, a control unit is provided which is designed and configured for automatically carrying out the method presented herein. For this purpose, for example, a corresponding computer program (software) can be loaded into a processor of the control unit and run during operation of the field-of-view display device.

According to a further aspect, a projection unit is provided for the above field-of-view display device. The projection unit can be enclosed, for example, by a protective housing (with or without a transparent cover plate). It comprises the mentioned image generator, for which in principle any image-generating technology also suitable for use in a vehicle if needed is suitable. For example, it can be a flat display screen or a waveguide display, but also a projector-based image generator. The projection unit can also comprise the above control unit, which is designed to actuate the image generator and possibly also the adjustable imaging and/or projection optical unit, in order to carry out the method presented herein. Depending on the embodiment variant, the projection unit can furthermore in particular also comprise the above-mentioned imaging and/or projection optical unit.

According to a further aspect, the above field-of-view display device is provided, which comprises the mentioned projection unit and a reflection pane arranged in the beam path of the light beam bundle output thereby. The reflection pane is arranged/to be arranged here in the field of view of a user and designed such that it reflects the light beam bundle to the eyebox predetermined for the user, by which the display content is displayable to him as a floating real or virtual image. The reflection pane can, but does not necessarily have to, be at least partially transparent, so that the user can also see the real surroundings through it.

According to a further aspect, the above vehicle is provided. The vehicle comprises a passenger compartment and a vehicle window, which at least partially delimits it, in particular a windshield. Furthermore, the field-of-view display device presented above is provided in the vehicle, the projection unit of which can be arranged in the passenger compartment, in particular in the interior of an instrument panel arranged below the windshield, and the reflection pane of which can be designed as a section of the vehicle window or as a combiner pane arranged in the passenger compartment.

The above aspects of the invention and the embodiments and specific designs thereof will be explained in more detail hereinafter on the basis of examples shown in the appended drawings. The drawings are to be understood as schematic illustrations and as not to scale.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a longitudinal sectional view of a vehicle having a field-of-view display device according to an exemplary embodiment of the invention, which is designed for a virtual image display;

FIG. 2 shows a longitudinal sectional view of a vehicle having a field-of-view display device according to a further exemplary embodiment of the invention, which is designed to generate a real image floating in the vehicle interior;

FIG. 3 shows a schematic comparative representation of the image generation of a field-of-view display device from the viewpoint of each individual eye of a user in the method according to an exemplary embodiment of the invention, wherein the predistortion is applied for the right eye ascertained as dominant; and

FIG. 4 shows a schematic comparative representation of the image generation of a field-of-view display device from the viewpoint of each individual eye of a user according to the method from the prior art, wherein the predistortion is applied for the cyclopean eye.

### DETAILED DESCRIPTION OF THE DRAWINGS

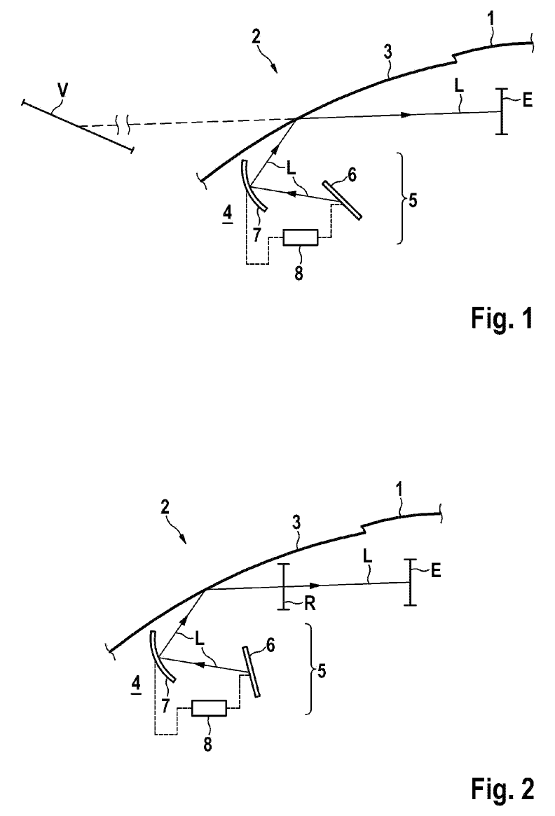

All of the different embodiments, variants, and specific design features mentioned above in the description and in the following claims, of the method, the control unit, the projection unit, the field-of-view display device, and the vehicle according to the above aspects of the invention can be implemented in the examples shown in FIGS. 1 to 3, also alternatively or additionally to the features shown therein. They are therefore not all repeated once again hereinafter. This applies accordingly to the term definitions and effects already indicated above with respect to individual features which are shown in FIGS. 1-3.

FIG. 1 shows a very simplified schematic longitudinal sectional view of an exemplary embodiment of a vehicle 1 having a field-of-view display device 2 presented herein, which is designed solely by way of example here to generate a virtual image V in the field of view of a user in a virtual image plane located almost in front of the vehicle 1 (again solely by way of example). The vehicle 1 is in this example a motor vehicle, which is only indicated by its windshield 3 in FIG. 1, which is used as a reflection pane of the field-of-view display device 2. A projection unit 5 of the field-of-view display device 2 is arranged underneath this in an instrument panel 4 (not shown in more detail). It is, again solely by way of example, a head-up display (HUD).

The projection unit 5 contains an image generator 6 designed to generate a desired display content, in this example an LCD (liquid crystal display). The light beam bundle L originating from its display surface, which transports the generated display content to an eyebox E of the user (solely by way of example a driver here, not shown separately) in the vehicle 1 and is also called “projection light” herein, is indicated in simplified form by its center beam, which leads approximately from a center of the display surface to a center of the eyebox E.

In the further beam path of the light beam bundle L, the projection unit 5 in this specific example comprises an imaging and/or projection optical unit, which comprises a concave mirror 7 adjustable for the adjustment of the eyebox position. The image generator 6 and the concave mirror 7 are arranged and designed here such that the light beam bundle L leaves the projection unit 5 in a suitable form and direction in order to then be reflected from the reflection pane 3 to the eyebox E and to thus display to the user the display content as a virtual image V having desired display properties. The image generator 6, in this example its image-generating display surface, is arranged here at a suitable display tilt angle with respect to the mentioned center beam in order to obtain a desired angle of inclination of the virtual image plane.

Furthermore, the projection unit comprises a control unit 8, which is configured for carrying out a method according to an exemplary embodiment of the invention and is designed for a corresponding actuation of the image generator 6 and for dynamic determination of the eye positions or for the readout of the sensors (not shown) provided for this purpose.

In this method, current positions of both user eyes are ascertained continuously during operation of the field-of-view display device 2. In this specific example, a dynamic (i.e., dependent on the currently determined eye positions) warping (predistortion) for use by the image generator 6 is furthermore provided by a calibration of the overall HUD system carried out in preparation (for example, after the vehicle assembly), which, inter alia, compensates for the vehicle-specific tolerances.

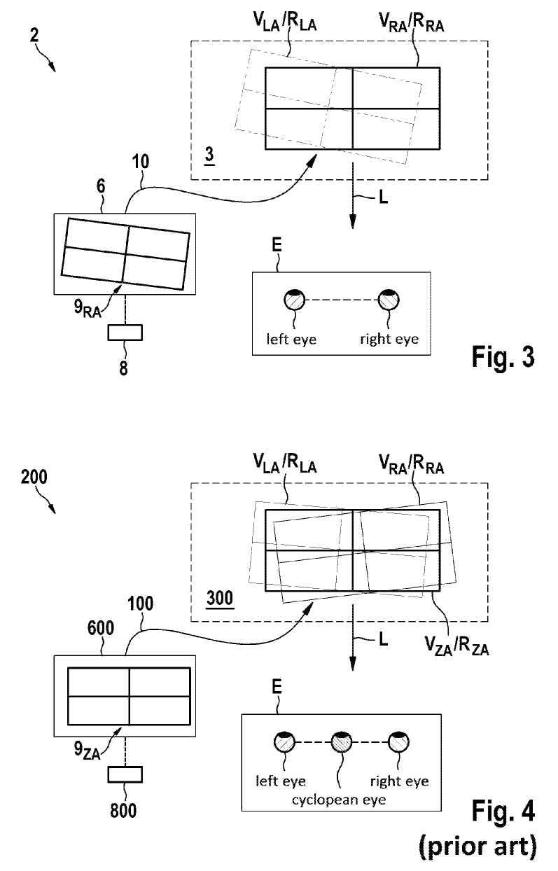

Furthermore, this method makes use of the fact that most (but not all!) humans have a more or less strongly pronounced dominance of one eye. If information is stored in the control unit 8 about which is the dominant eye of the driver, the dynamic warping is adapted directly to the detected position of his dominant eye and a perfect HUD image V is therefore displayed to the driver of the vehicle 1 (cf. FIG. 3). In contrast, if no information about the dominance of an eye of this user is stored or if both of his eyes are stored as dominant, the dynamic warping is applied to a cyclopean eye positioned precisely between his left and his right eye (cf. FIG. 4), in other words the method proceeds as in the prior art without consideration of the eye dominance.

The routine for determining the dominant eye of a user is integrated in the method presented herein and can be activated, for example, via an operating menu and/or automatically upon the initial use. It is tailored to the specific display properties and performance requirements of the respective field-of-view display device 2, based on subjective selection of the respective user himself, and is simple, fast, and extremely user-friendly in this case.

For this purpose, a pattern HUD image is alternately displayed to the user, which is generated in the image generator 6 from a suitable pattern display content (not shown separately) and is optimized here once for the left and once for the right eye position by the respective dynamic warping. The observer can then select via a suitable user interface (upon a query output at the same time) which of these two image variants of the same pattern has made the subjectively better/more pleasant impression on him. If the user responds to this query, the eye associated with the selected image is stored as his dominant eye. The user only has to do this procedure once when he is still unknown to the vehicle 1. The vehicle 1 thereafter recognizes him again and automatically installs the correct warping.

The calibration for the dynamic warping requires in this example multiple calibration positions in the eyebox E in order to be able to adapt the warping to the respective eye position. Five camera positions are an absolute minimum here (calibration positions in the corners of the eyebox E and in its center). Warping can be determined by interpolation for the eye positions which are located between the camera positions. The inaccuracies which arise due to the interpolation can be reduced if more camera positions are used in the calibration.

The subjectively perceived quality of the HUD image V can be improved using this method in that the user has an image V adapted to his individual viewing habits shown to him. The approach of the cyclopean eye can still be used for users having a weakly pronounced dominance of one eye. These users have no improvement in this method, but also no worsening of the HUD result in relation to the conventional display (cf. FIG. 4).

FIG. 2 shows a longitudinal sectional view of a vehicle 1 having a field-of-view display device 2 according to a further exemplary embodiment of the invention, which (as the only difference from FIG. 1) is designed to generate a real image R floating in the vehicle interior (instead of the virtual image V of FIG. 1). Otherwise, reference is made to the above description of FIG. 1 to avoid repetitions, which also applies accordingly here.

FIG. 3 shows a schematic comparison representation of the image generation of a field-of-view display device 2 from the viewpoint of each individual eye of a user, wherein the predistortion is applied for the right eye determined as dominant according to the method according to an exemplary embodiment of the invention. The field-of-view display device 2 can in particular be the field-of-view display device 2 of FIG. 1 (with or without the concave mirror 7) or the field-of-view display device 2 of FIG. 2, so that to avoid repetitions, reference is made to the above description of the field-of-view display device 2 and its operating method with reference to FIGS. 1 and 2. The field-of-view display device 2 also does not necessarily have to be installed in a vehicle 1, but rather can also be used, for example, in a building or as part of a wearable device (helmet having visor etc.).

The image generator 6 of the field-of-view display device 2 is shown greatly simplified in FIG. 3, in a top view of its image-generating surface and not at its actual size and position in relation to the reflection pane 3 of the field-of-view display device 2. This representation best shows the predistortion of the display content 9RA generated in the image generator 6, which is optimized for the dominant right eye of the user. Both eyes of the user are located in FIG. 3 in the eyebox E predetermined for this purpose of the field-of-view display device 2 and look at the reflection pane 3, to which the display content 9RA generated in the image generator 6 is transmitted via the overall optical system 10 of the field-of-view display device 2 (not shown in detail in FIG. 3, see FIGS. 1 and 2 for this purpose). The light beam bundle L, which transports the display content 9RA reaches the user eyebox E via reflection on the reflection pane 3.

FIG. 3 shows the resulting HUD image VLA or RLA, as is thus seen by the left eye of the user, and the resulting HUD image VRA or RRA, as is thus seen by the right eye of the user. Since the dominant eye and its position are known, the warping (predistortion) is adapted so that a perfect HUD image VRA or RRA is always presented to this eye, while the other eye of the user sees an HUD image VLA or RLA shifted and rotated in relation thereto (shown somewhat exaggerated for reasons of clarity in FIG. 3).

FIG. 4 shows, in a similar overview illustration as in FIG. 3, a field-of-view display device 200 known from the prior art (also an HUD here), the control unit 800, image generator 600, reflection pane 300, and the overall optical system 100 of which are designed so that the HUD image VZA / RZA is perfectly displayed for a cyclopean eye, which would be located between the real positions of the right and the left eye of the user, while the left and the right eye of the user each see a somewhat rotated and shifted image VLA / RLA or VRA / RRA. In other words, the predistortion of the display content 9ZA generated in the image generator 600 is optimized here, in the absence of information about a dominant eye of the user, for a cyclopean eye located in the middle between his eyes. As already mentioned, the latter can also be used in the scope of the present method as an exceptional solution if a user cannot or does not wish to decide between the two representations of the pattern display content optimized for only one of his eyes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

1 vehicle

2 field-of-view display device, HUD

200 conventional field-of-view display device, HUD

3 windshield, reflection pane

300 conventional reflection pane

4 instrument panel

5 projection unit

6 image generator

600 conventional image generator

7 concave mirror

8 control unit

800 conventional control unit

9_{RA} display content which is optimized for the dominant right eye of the user

9_{ZA} display content which is optimized for the cyclopean eye

10 overall optical system

100 conventional overall optical system

V_{LA} / R_{LA} HUD image seen from the left eye of the user

V_{RA} / R_{RA} HUD image seen from the right eye of the user

V_{ZA} / R_{ZA} HUD image seen from the cyclopean eye

L light beam bundle, also called projection light

E eyebox

V virtual image

R real image, floating

What is claimed is:

1. A method for operating a field-of-view display device, which includes an image generator configured to generate a light beam bundle having desired display content, which is identical for both eyes of a user, and a reflection pane arranged in a field of view of the user, so that the display content is displayed to the user via reflection on the reflection pane as a real or virtual image floating in air, the method comprising:
dynamically determining current positions of both user eyes during operation of the field-of-view display device;
optimizing the image display, for each point within an eyebox predetermined for the user eyes, based on a predistortion of the display content for observation with a single eye positioned at the each point;
displaying a predetermined pattern display content to the user upon a predetermined trigger, which is predistorted with a time interval that can be resolved by a human eye in succession once for the current position of a left eye of the user and once for a right eye of the user, accompanied or followed by a query on a subjective preference decision of the user between representations of the left eye and the right eye and reception of a response input of the user indicating selection of a dominant eye and storage of the dominant eye; and
operating a field-of-view display content using the predistortion of the display content for a respective current position of the eye of the user stored as the dominant eye or for a respective position located in a center between the user eyes.

2. The method according to claim 1, wherein the pattern display content extends over at least half of a respective linear surface or angle dimension of a display area in the field of view of the user which can be covered overall by the field-of-view display device.

3. The method according to claim 1, wherein the pattern display content extends over an entire respective linear surface or angle dimension of a display area in the field of view of the user which can be covered overall by the field-of-view display device.

4. The method according to claim 1, wherein the predetermined trigger includes:
an automatic recognition of a new user of the field-of-view display device;
reception of a user-side initial login as the user of the field-of-view display device; or
reception of a user-side input predetermined separately for determination of the dominant eye.

5. The method according to claim 2, wherein the predetermined trigger includes:
an automatic recognition of a new user of the field-of-view display device;
reception of a user-side initial login as the user of the field-of-view display device; or
reception of a user-side input predetermined separately for determination of the dominant eye.

6. The method according to claim 1, wherein
the predistortion is determined by a calibration procedure carried out at a plurality of calibration positions within the user eyebox, in which a compensatory predistortion of structural tolerance deviations of the field-of-view display device is determined at each calibration position based on at least one predetermined calibration display content and an optical camera replacing a single eye, which records the resulting image, by a predetermined manual or automated calibration routine; and
the predistortion is determined by an interpolation for all positions located between the calibration positions.

7. The method according to claim 2, wherein
the predistortion is determined by a calibration procedure carried out at a plurality of calibration positions within the user eyebox, in which a compensatory predistortion of structural tolerance deviations of the field-of-view display device is determined at each calibration position based on at least one predetermined calibration display content and an optical camera replacing a single eye, which records the resulting image, by a predetermined manual or automated calibration routine; and
the predistortion is determined by an interpolation for all positions located between the calibration positions.

8. The method according to claim 6, wherein the calibration positions comprise at least five calibration positions, which are defined in a two-dimensional eyebox oriented transverse to a beam propagation by its four eyebox corners and an eyebox center.

9. The method according to claim 1, wherein the field-of-view display device comprises an imaging or projection optical unit arranged in a beam path of the light beam bundle generated by the image generator and configured such that the light beam bundle is projected in a predetermined form and direction onto the reflection pane, in order to be reflected therefrom to the eyes of the user and to thus display to the user the display content as a floating real or virtual image.

10. A control unit configured to automatically carry out a method according to claim 1.

11. A projection apparatus for a field-of-view display device in a vehicle, the projection apparatus comprising:
an image generator configured to generate a light beam bundle having desired display content;
a control unit configured to actuate the image generator to
dynamically determine current positions of both user eyes during operation of the field-of-view display device;
optimize the image display, for each point within an eyebox predetermined for the user eyes, based on a predistortion of the display content for observation with a single eye positioned at the each point;
display a predetermined pattern display content to the user upon a predetermined trigger, which is predistorted with a time interval that can be resolved by a human eye in succession once for the current position of a left eye of the user and once for a right eye of the user, accompanied or followed by a query on a subjective preference decision of the user between representations of the left eye and the right eye and reception of a response input of the user indicating selection of a dominant eye and storage of the dominant eye; and
operate a field-of-view display content using the predistortion of the display content for a respective current position of the eye of the user stored as the dominant eye or for a respective position located in a center between the user eyes; and
an imaging or projection optical unit arranged in a beam path of the light beam bundle generated by the image generator and configured such that the light beam bundle leaves the projection unit in a predetermined form and direction in order to subsequently be reflected from a reflection pane arranged in the field of view of a user to eyes of the user and to display the display content as a floating real or virtual image.

12. A field-of-view display device for a vehicle comprising:
a projection apparatus according to claim 11; and
a reflection pane arranged in the beam path of the light beam bundle output by the projection unit, which is arranged in the field of view of the user and configured such that the reflection pane reflects the light beam bundle to an eyebox (E) predetermined for the eyes of the user, by which the display content is displayable to the user as a floating real or virtual image.

13. A motor vehicle having longitudinal, transverse, and vertical directions perpendicular to one another of a vehicle-fixed Cartesian coordinate system, the vehicle comprising:
a passenger compartment having a vehicle window, which at least partially delimits the passenger compartment, including a windshield; and
a field-of-view display device according to claim 12, the projection unit of which is arranged in the passenger compartment in an interior of an instrument panel arranged under the windshield and the reflection pane of which is configured as a section of the vehicle window or as a combiner pane arranged in the passenger compartment.
